(19) United States
(12) Patent Application Publication
(10) Pub. No.: US 2023/0388097 A1
(43) Pub. Date: Nov. 30, 2023

(54) RELAY DEVICE, TIME SYNCHRONIZATION SYSTEM, AND PROGRAM

(71) Applicant: NIPPON TELEGRAPH AND TELEPHONE CORPORATION, Tokyo (JP)

(72) Inventors: Yuki YAMADA, Musashino-shi, Tokyo (JP); Takashi NAKANISHI, Musashino-shi, Tokyo (JP); Shinichi YOSHIHARA, Musashino-shi, Tokyo (JP); Go YAZAWA, Musashino-shi, Tokyo (JP)

(73) Assignee: NIPPON TELEGRAPH AND TELEPHONE CORPORATION, Tokyo (JP)

(21) Appl. No.: 18/031,886

(22) PCT Filed: Nov. 5, 2020
(86) PCT No.: PCT/JP2020/041282

§ 371 Date: Apr. 14, 2023

(51) Int. Cl. H04L 7/00; H04L 7/04

(52) U.S. Cl. CPC H04L 7/0016; H04L 7/041

(57) ABSTRACT

A relay device includes a device internal clock to indicate time; a memory to store information; a communication unit to transmit and receive a signal including a synchronization signal and a normal signal to and from a master and a slave. Further, there is a retention time processing unit to store synchronization signal information indicating the synchronization signal received by the communication unit in the memory and extract the synchronization signal information from the memory when a retention setting time longer than a first predetermined time elapses from the reception of the synchronization signal by using the time indicated by the device internal clock; and a transmission signal control unit to control the communication unit to stop transmitting the normal signal when the first predetermined time elapses from the reception of the synchronization signal and transmit the synchronization signal indicating the synchronization signal information.

### TECHNICAL FIELD

The present disclosure relates to a relay device, a time synchronization system, and a program for performing time synchronization between a master and a slave.

### BACKGROUND ART

In order to provide a service by connecting devices installed in a plurality of bases apart from each other via a communication network, it is required to perform time synchronization in which times of the devices are aligned according to a function of application software. In particular, a service using a high-speed communication network such as a fifth generation mobile communication system (5G) requires highly accurate time synchronization in the order of nanoseconds.

In order to implement this time synchronization, there are conventionally known technologies such as the Network Time Protocol (NTP) and the Institute of Electrical and Electronics Engineers (IEEE) 1588 disclosed in Non Patent Literature 1. Here, a method of performing time synchronization by using the precision time protocol (PTP) in IEEE 1588 will be described with reference to FIG. 10. This method is used in, for example, a system in which a master 96 that is a device for distributing time and a slave 97 are connected to a communication network. In the system, time synchronization is performed such that time of a clock of the slave 97 is aligned with time indicated by a clock of the master 96.

First, the master 96 transmits a sync signal to the slave 97 at a master transmission time t₁ clocked by using the clock of the master 96. The master 96 further transmits a master transmission time signal indicating the master transmission time t₁ at which the sync signal has been transmitted to the slave 97.

The slave 97 receives the sync signal and the master transmission time signal from the master 96 and stores slave reception time information indicating a slave reception time t₂ at which the sync signal has been received, the slave reception time being clocked by using the clock of the slave 97. Thereafter, the slave 97 transmits a delay req signal to the master 96 at a slave transmission time t₃ clocked by using the clock of the slave 97 and stores slave transmission time information indicating the slave transmission time t₃.

The master 96 receives the delay req signal transmitted from the slave 97. Thereafter, the master 96 transmits, to the slave 97, a delay resp signal and a master reception time signal indicating a master reception time t₄ at which the delay req signal has been received, the master reception time being clocked by using the clock of the master 96.

The slave 97 receives the delay resp signal and the master reception time signal transmitted from the master 96. The slave 97 calculates a time difference Δt shown in Expression (1) on the basis of the master transmission time t₁, the slave reception time t₂, the slave transmission time t₃, and the master reception time t₄. In Expression (1), a delay time generated in forward-path communication is assumed to be equal to a delay time generated in return-path communication.

Δt=((t₂−t₁)−(t₄−t₃))/2 (1)

The slave 97 corrects the time indicated by the slave internal clock of the slave 97 such that Δt=0 is established in Expression (1). Therefore, time synchronization between the master 96 and the slave 97 is implemented.

As described above, the method disclosed in Non Patent Literature 1 assumes that the delay time in the forward-path communication is equal to the delay time in the return-path communication when time synchronization is performed between the master 96 and the slave 97 installed in a plurality of bases apart from each other. However, in a configuration in which the master 96 and the slave 97 transmit and receive a signal via a relay device 91 as illustrated in FIG. 11, a queuing delay may occur in transmission of a synchronization signal due to transmission of a normal signal in the relay device. The synchronization signal is a signal used for performing time synchronization and includes a sync signal and a delay req signal. The normal signal is a signal other than the synchronization signal. A delay time caused by the queuing delay depends on traffic of normal signals transmitted and received by the relay device 91. Therefore, the delay time in the forward-path communication may be different from the delay time in the return-path communication. Therefore, if the slave 97 corrects the time as described above by using Expression (1), accuracy of time synchronization may decrease.

In order to prevent such a decrease in the accuracy of time synchronization, Non Patent Literature 2 discloses a method of preferentially transmitting and receiving a high-priority signal including a synchronization signal by using a method defined in IEEE 802.1Qbu.

Specifically, in the method using IEEE 802.1Qbu, upon receipt of a high-priority signal, the relay device stops transmitting a low-priority signal and transmits the high-priority signal. According to the method, in a case where the relay device receives a high-priority signal during transmission of a low-priority signal, a waiting time may be generated in transmission of the high-priority signal until transmission of the currently transmitted low-priority signal is completed. Therefore, the transmission of the high-priority signal may be delayed depending on a length of the low-priority signal. Further, the high-priority signal includes a synchronization signal and a signal other than the synchronization signal, and thus, in a case where the signal other than the synchronization signal included in the high-priority signal is preferentially transmitted, a waiting time may be generated in transmission of the synchronization signal until the transmission of the signal is completed.

Therefore, in order to solve the problem caused by the method using IEEE 802.1Qbu, in a method using IEEE 802.3br disclosed in Non Patent Literature 3, in a case where a relay device receives a high-priority signal during transmission of a low-priority signal, the relay device divides the currently transmitted low-priority signal. Then, the relay device causes the high-priority signal to interrupt the divided low-priority signals and transmits the high-priority signal (FP method).

There is also known a technology in which a relay device includes a master function unit and a slave function unit on an input side and an output side, respectively. For example, in the boundary clock (BC) technology, time synchronization is performed between the master and the slave function unit of the relay device, then time synchronization is performed between the master function unit of the relay device and the slave, and the relay device corrects time indicated by a clock of the device. Further, in the transparent clock (TC) technology, a delay time is calculated on the basis of a difference between a time at which the relay device receives a signal and a time at which the relay device transmits the signal. Then, the slave receives the delay time from the relay device and corrects the time indicated by the clock of the slave on the basis of the delay time.

### CITATION LIST

### Non Patent Literature

Non Patent Literature 1: IEEE Standard for a Precision Clock Synchronization Protocol for Networked Measurement and Control Systems, [Searched on Oct. 28, 2020], the Internet <URL: https://ieeexplore.ieee.org/document/4579760>
Non Patent Literature 2: M. L'evesque et al, “ptp++: A Precision Time Protocol Simulation Model for OMNeT++/INET,” Proceedings of the “OMNeT++ Community Summit 2015,” [Searched on Oct. 28, 2020], the Internet <URL:https://arxiv.org/pdf/1509.03169.pdf>
Non Patent Literature 3: IEEE 802.3br Interspersing Express Traffic(IET) Task Force(TF) Baseline, [Searched on Oct. 28, 2020], the Internet <URL:http://www.ieee802.org/3/br/Baseline/8023-IET-TF-1405_Winkel-iet-Baseline-r4.pdf>

### SUMMARY OF INVENTION

### Technical Problem

However, according to the method disclosed in Non Patent Literature 3, the master 96 and the slave 97 that receive a low-priority signal need to have a function of restoring the divided low-priority signals. Thus, there is a problem that the time synchronization system cannot be simply configured. In a case where the BC technology is used in a system in which a master and a slave communicate with each other via a relay device, the relay device needs to have a master function and a slave function. Thus, the relay device has a complicated configuration. In a case where the TC technology is used, as described above, the slave receives the delay time from the relay device and corrects the time on the basis of the delay time. Therefore, the slave has a high processing load, and, particularly in a case where communication is performed via a large number of relay devices, the processing load of the slave is a large problem.

An object of the present disclosure made in view of such circumstances is to provide a relay device, time synchronization system, and program capable of easily implementing highly accurate time synchronization in a system in which a master and a slave communicate with each other via the relay device.

### Solution to Problem

In order to solve the above problem, a relay device according to the present disclosure includes: a device internal clock configured to indicate time; a storage unit configured to store information; a communication unit configured to transmit and receive a signal including a synchronization signal and a normal signal to and from a master and a slave; a retention time processing unit configured to store synchronization signal information indicating the synchronization signal received by the communication unit in the storage unit and extract the synchronization signal information from the storage unit when a retention setting time longer than a first predetermined time elapses from the reception of the synchronization signal by using the time indicated by the device internal clock; and a transmission signal control unit configured to control the communication unit to stop transmitting the normal signal when the first predetermined time elapses from the reception of the synchronization signal and transmit the synchronization signal indicating the synchronization signal information when the synchronization signal information is extracted from the storage unit.

Further, in order to solve the above problem, a time synchronization system according to the present disclosure includes: the above relay device; and a master and slave configured to communicate with the relay device, in which: the communication unit transmits, from the master to the slave, a master time signal indicating a master time at which the master transmits and receives the synchronization signal; and the slave includes a slave internal clock and corrects the slave internal clock on the basis of a slave time indicating a time at which the slave transmits and receives the synchronization signal, the master time, and the retention setting time.

Further, in order to solve the above problem, a program according to the present disclosure causes a computer to function as the relay device described above.

### Advantageous Effects of Invention

According to a relay device, time synchronization system, and program according to the present disclosure, it is possible to easily implement highly accurate time synchronization.

### BRIEF DESCRIPTION OF DRAWINGS

FIG. 1 is a schematic diagram of a time synchronization system according to a first embodiment of the present disclosure.

FIG. 2 is a timing chart showing a timing at which a relay device in FIG. 1 transmits a signal received from a master to a slave.

FIG. 3 is a timing chart showing a timing at which the relay device in FIG. 1 transmits a signal received from a slave to a master.

FIG. 4 illustrates a configuration example of a master in FIG. 1.

FIG. 5 illustrates a configuration example of a slave in FIG. 1.

FIG. 6 is a sequence diagram showing an operation of the time synchronization system in FIG. 1.

FIG. 7 is a flowchart showing first relay processing in FIG. 6.

FIG. 8 is a schematic diagram of a time synchronization system according to a third embodiment of the present disclosure.

FIG. 9 is a sequence diagram showing an operation of the time synchronization system in FIG. 8.

FIG. 10 is a sequence diagram showing an operation of a conventional time synchronization system.

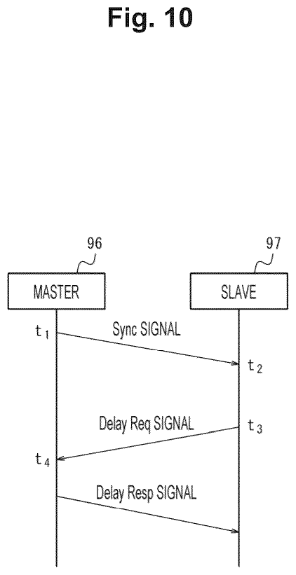

FIG. 11 illustrates a configuration example of a system in which a relay device is added to the time synchronization system that performs the operation in FIG. 10.

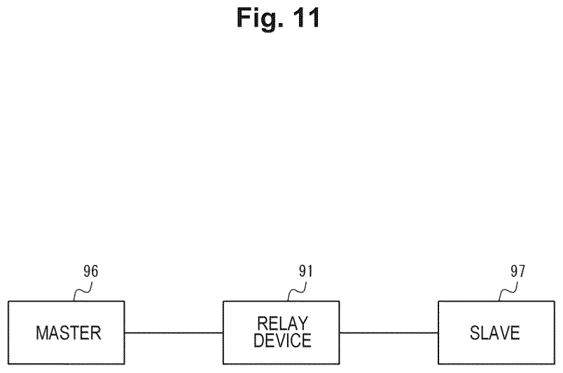

### DESCRIPTION OF EMBODIMENTS

First, embodiments of the present disclosure will be described with reference to the drawings.

### First Embodiment

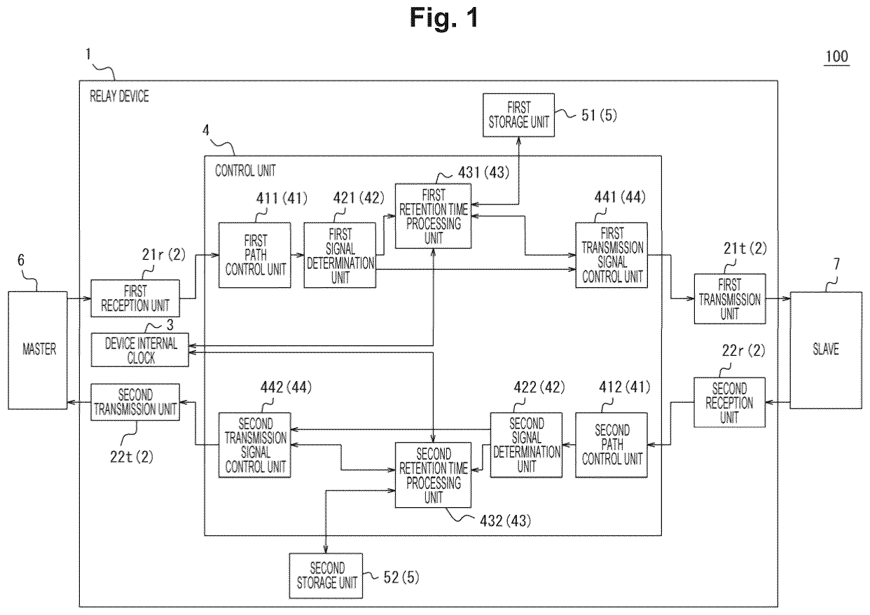

An entire configuration of a first embodiment will be described with reference to FIG. 1. FIG. 1 is a schematic diagram of a time synchronization system 100 according to the first embodiment of the present invention.

As illustrated in FIG. 1, the time synchronization system 100 according to the first embodiment includes a relay device 1, a master 6, and a slave 7. The master 6 and the slave 7 communicate with each other via the relay device 1. The relay device 1, the master 6, and the slave 7 are each configured as a computer. Examples of the computer include a server computer, supercomputer, mainframe, tablet computer, laptop computer, and smartphone. The computer can be any computer such as a general-purpose computer, dedicated computer, workstation, personal computer (PC), or digital notepad.

### <Configuration of Relay Device>

The relay device 1 communicates with both the master 6 and the slave 7. The relay device 1 includes a communication unit 2, a device internal clock 3, a control unit 4, and a storage unit 5.

The communication unit 2 includes a communication interface including a reception interface and a transmission interface. The communication unit 2 transmits and receives a signal to and from both the master 6 and the slave 7. The signal includes a synchronization signal and a normal signal other than the synchronization signal. The synchronization signal is, for example, one of precision time protocol (PTP) signals including a sync signal and a delay req signal. In this embodiment, a delay resp signal included in the PTP signals is a normal signal.

The communication unit 2 receives, from the master 6, a master time signal indicating a master time at which the master 6 transmits and receives a synchronization signal and transmits the master time signal to the slave 7. The master time signal includes a master transmission time signal indicating a master transmission time t₁ and a master reception time signal indicating a master reception time t₄. The master transmission time t₁ is a time at which the master 6 transmits a sync signal, the time being clocked by using a master internal clock 62 described in detail later. The master reception time t₄ is a time at which the master 6 receives a delay req signal, the time being clocked by using the master internal clock 62.

The communication unit 2 includes a first reception unit 21r, a first transmission unit 21t, a second reception unit 22r, and a second transmission unit 22t.

The first reception unit 21r and the second reception unit 22r include the reception interface and receive a signal through a receiver. The first reception unit 21r and the second reception unit 22r output the received signal to the control unit 4. Specifically, the first reception unit 21r receives a sync signal and a normal signal transmitted from the master 6 and outputs the sync signal and the normal signal to a first path control unit 411 described later of the control unit 4. The first reception unit 21r receives a master time signal transmitted from the master 6 and outputs the master time signal to the first path control unit 411. The master time signal may be included in the sync signal or may be transmitted and received to follow the sync signal. The second reception unit 22r receives a delay req signal and a normal signal transmitted from the slave 7 and outputs the delay req signal and the normal signal to a second path control unit 412 described later of the control unit 4.

The first transmission unit 21t and the second transmission unit 22t include the transmission interface and transmit a signal via a transmitter under the control of a first transmission signal control unit 441. Specifically, the first transmission unit 21t transmits the sync signal and the normal signal received by the first reception unit 21r to the slave 7. The first transmission unit 21t transmits the master time signal received by the first reception unit 21r to the slave 7. The second transmission unit 22t transmits the delay req signal and the normal signal received by the second reception unit 22r to the master 6.

The device internal clock 3 indicates time. The time indicated by the device internal clock 3 is used by the control unit 4 as described in detail later.

The control unit 4 may be configured by dedicated hardware or may be configured by one or more processors. The processor can be a general-purpose processor or a dedicated processor specialized for specific processing, but is not limited thereto. The processor may be, for example, a central processing unit (CPU), graphics processing unit (GPU), digital signal processor (DSP), or application specific integrated circuit (ASIC).

The control unit 4 includes a path control unit 41, a signal determination unit 42, a retention time processing unit 43, and a transmission signal control unit 44.

The path control unit 41 determines a transmission destination of a signal received by the communication unit 2. When determining the transmission destination of the signal, the path control unit 41 outputs the signal to the signal determination unit 42. The path control unit 41 includes a first path control unit 411 and a second path control unit 412. The first path control unit 411 determines a transmission destination of a signal received by the first reception unit 21r. When determining the transmission destination of the signal, the first path control unit 411 outputs the signal to the first signal determination unit 421. The second path control unit 412 determines a transmission destination of a signal received by the second reception unit 22r. When determining the transmission destination of the signal, the second path control unit 412 outputs the signal to the second signal determination unit 422.

The signal determination unit 42 determines whether the signal received by the communication unit 2 is a synchronization signal or a normal signal. When determining that the signal is a synchronization signal, the signal determination unit 42 outputs the synchronization signal to the retention time processing unit 43. When determining that the signal is a normal signal, the signal determination unit 42 outputs the normal signal to the transmission signal control unit 44.

The signal determination unit 42 includes a first signal determination unit 421 and a second signal determination unit 422.

The first signal determination unit 421 determines whether the signal received by the first reception unit 21r is a sync signal or a normal signal. When determining that the signal is a sync signal, the first signal determination unit 421 outputs the sync signal to a first retention time processing unit 431 described later. When determining that the signal is a normal signal, the first signal determination unit 421 outputs the normal signal to the first transmission signal control unit 441 described later. The second signal determination unit 422 determines whether the signal received by the second reception unit 22r is a delay req signal or a normal signal. When determining that the signal is a delay req signal, the second signal determination unit 422 outputs the delay req signal to a second retention time processing unit 432 described later. When determining that the signal is a normal signal, the second signal determination unit 422 outputs the normal signal to a second transmission signal control unit 442 described later.

The retention time processing unit 43 retains the synchronization signal received by the communication unit 2 and determined by the signal determination unit 42 by using the time indicated by the device internal clock 3.

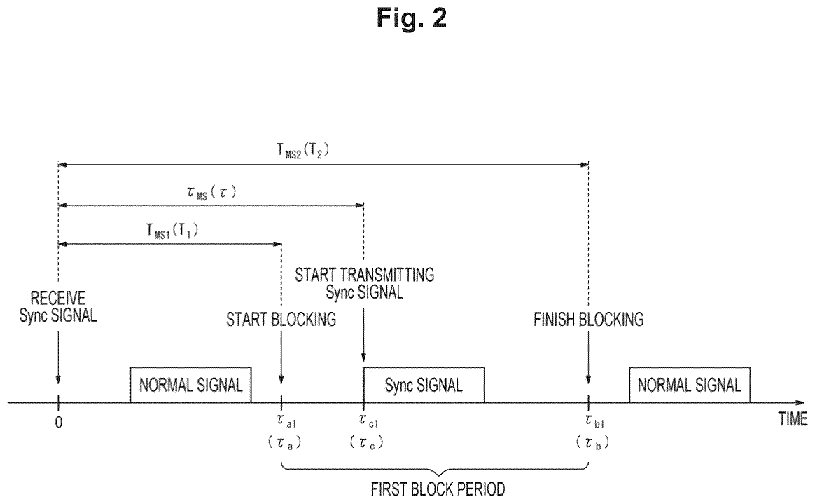

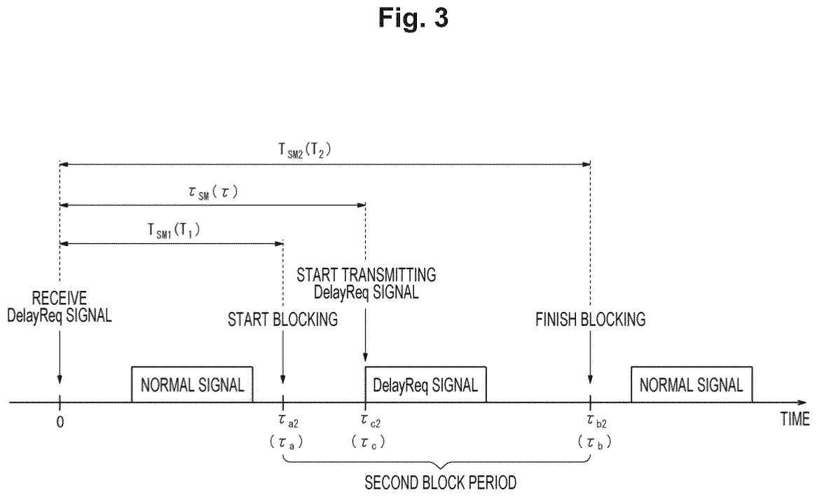

Specifically, the retention time processing unit 43 stores, in the storage unit 5, synchronization signal information indicating the synchronization signal determined by the signal determination unit 42. When a retention setting time τ longer than a first predetermined time T₁ elapses from the reception of the synchronization signal by using the time indicated by the device internal clock 3, the retention time processing unit 43 extracts the synchronization signal information from the storage unit 5. The first predetermined time T₁ and the retention setting time τ are arbitrary setting values and may be values set in advance in the device or may be optimum values determined by the device. The first predetermined time T₁ and the retention setting time τ may be set such that a period of time between a time τₐ at which the first predetermined time T₁ elapses from the reception of the synchronization signal and a time τ_{c} at which the retention setting time τ elapses from the reception of the synchronization signal, which is illustrated in FIGS. 2 and 3, is equal to or longer than a period of time from the start to the end of transmission of a normal signal. The period of time from the start to the end of the transmission of the normal signal may be determined on the basis of traffic of a communication network that propagates a signal transmitted from the relay device 1. The retention time processing unit 43 outputs the synchronization signal indicated by the synchronization signal information extracted from the storage unit 5 to the transmission signal control unit 44.

The retention time processing unit 43 includes a first retention time processing unit 431 and a second retention time processing unit 432. The first predetermined time T₁ includes a first forward-path predetermined time T_{MS1} and a first return-path predetermined time T_{SM1}. The retention setting time τ includes a forward-path retention setting time τ_{MS} and a return-path retention setting time τ_{SM}.

The first retention time processing unit 431 retains the sync signal determined by the first signal determination unit 421 by using the time indicated by the device internal clock 3.

Specifically, when the first signal determination unit 421 determines that the signal is a sync signal, the first retention time processing unit 431 stores synchronization signal information indicating the sync signal in a first storage unit 51. As illustrated in FIG. 2, the first retention time processing unit 431 determines whether or not the forward-path retention setting time τ_{MS} longer than the first forward-path predetermined time T_{MS1} has elapsed from the reception of the sync signal (in the example of FIG. 2, whether or not a current time is at or after a time τ_{c1}). When determining that the forward-path retention setting time τ_{MS} has not elapsed, the first retention time processing unit 431 continuously stores the synchronization signal in the first storage unit 51. When determining that the forward-path retention setting time τ_{MS} has elapsed, the first retention time processing unit 431 extracts, from the first storage unit 51, the synchronization signal information indicating the sync signal stored in the first storage unit 51.

The first forward-path predetermined time T_{MS1} and the forward-path retention setting time τ_{MS} may be set such that a period of time between a time τₐ₁ at which the first forward-path predetermined time T_{MS1} elapses from the reception of the sync signal and the time τ_{c1} at which the forward-path retention setting time τ_{MS} elapses from the reception of the sync signal is equal to or longer than a period of time from the start to the end of transmission of a normal signal.

The first retention time processing unit 431 outputs the sync signal indicated by the synchronization signal information extracted from the storage unit 51 to the first transmission signal control unit 441 described later.

The second retention time processing unit 432 retains the delay req signal determined by the second signal determination unit 232 by using the time indicated by the device internal clock 3.

Specifically, when the second signal determination unit 422 determines that the signal is a delay req signal, the second retention time processing unit 432 stores synchronization signal information indicating the delay req signal in a second storage unit 52. As illustrated in FIG. 3, the second retention time processing unit 432 determines whether or not the return-path retention setting time Ism longer than the first forward-path predetermined time T_{MS1} has elapsed from the reception of the delay req signal (in the example of FIG. 3, whether or not the current time is at or after a time τ_{c2}). When determining that the return-path retention setting time Ism has not elapsed, the second retention time processing unit 432 continuously stores the synchronization signal information in the second storage unit 52. When determining that the return-path retention setting time ism has elapsed, the second retention time processing unit 432 extracts, from the second storage unit 52, the synchronization signal information indicating the delay req signal stored in the second storage unit 52.

The first return-path predetermined time T_{SM1} and the return-path retention setting time τ_{SM} may be set in a similar manner to the first forward-path predetermined time T_{MS1} and the forward-path retention setting time τ_{MS}.

The second retention time processing unit 432 outputs the delay req signal indicated by the synchronization signal information to the second transmission signal control unit 442 described later.

The transmission signal control unit 44 controls the communication unit 2 to transmit the synchronization signal output from the retention time processing unit 43.

The transmission signal control unit 44 further controls the communication unit 2 to transmit a normal signal by using the time indicated by the device internal clock 3 on the basis of a period of time that has elapsed from the reception of the synchronization signal. Specifically, as illustrated in FIGS. 2 and 3, when the first predetermined time T₁ elapses since the communication unit 2 has received the synchronization signal, the transmission signal control unit 44 controls the communication unit 2 to stop transmitting a normal signal received by the communication unit 2. When a second predetermined time T₂ elapses since the communication unit 2 receives the synchronization signal, the transmission signal control unit 44 controls the communication unit 2 to start transmitting the normal signal received by the communication unit 2. The second predetermined time T₂ is an arbitrary setting value longer than the retention setting time τ and may be a value set in advance in the device or may be an optimum value determined by the device.

The transmission signal control unit 44 includes the first transmission signal control unit 441 and the second transmission signal control unit 442.

First, control performed by the first transmission signal control unit 441 to transmit a signal will be described in detail.

The first transmission signal control unit 441 controls the first transmission unit 21t to transmit the sync signal output by the first retention time processing unit 431.

As illustrated in FIG. 2, the first transmission signal control unit 441 further controls the first transmission unit 21t to transmit a normal signal to the slave 7 on the basis of the time indicated by the device internal clock 3. Specifically, when the first forward-path predetermined time T_{MS1} elapses since the first reception unit 21r has received the synchronization signal (in the example of FIG. 2, at or after the time τₐ₁), the first transmission signal control unit 441 controls the first transmission unit 21t to stop transmitting a normal signal. Further, when a second forward-path predetermined time T_{MS2} elapses since the first reception unit 21r has received the synchronization signal (in the example of FIG. 2, at or after the time τ_{b1}), the first transmission signal control unit 441 controls the first transmission unit 21t to start transmitting the normal signal.

For example, the first transmission signal control unit 441 determines whether or not the current time is within a first block period. The first block period is a period of time from the time τₐ₁ at which the first forward-path predetermined time T_{MS1} elapses from a reception time at which the sync signal is received to the time τ_{b1} at which the second forward-path predetermined time T_{MS2} elapses from the reception time. The second forward-path predetermined time T_{MS2} is longer than the forward-path retention setting time TMS.

When determining that the current time is not within the first block period, the first transmission signal control unit 441 controls the first transmission unit 21t to transmit a normal signal. Meanwhile, when determining that the current time is within the first block period, the first transmission signal control unit 441 controls the first transmission unit 21t to stop transmitting the normal signal. Note that the normal signal received by the first reception unit 21r may be stored in a memory included in the relay device 1 until the normal signal is transmitted by the first transmission unit 21t.

Next, control performed by the second transmission signal control unit 442 to transmit a signal will be described in detail.

The second transmission signal control unit 442 controls the second transmission unit 22t to transmit the delay req signal output by the second retention time processing unit 432.

The second transmission signal control unit 442 further controls the second transmission unit 22t to transmit a normal signal to the master 6 on the basis of the time indicated by the device internal clock 3.

Specifically, when the first return-path predetermined time T_{MS1} elapses since the second reception unit 22r has received the synchronization signal (in the example of FIG. 3, at or after a time Ta₂), the second transmission signal control unit 442 controls the second transmission unit 22t to stop transmitting a normal signal. Further, when a second return-path predetermined time T_{SM2} elapses since the second reception unit 22r has received the synchronization signal (in the example of FIG. 3, at or after the time τ_{b1}), the second transmission signal control unit 442 controls the second transmission unit 22t to start transmitting the normal signal.

For example, the second transmission signal control unit 442 determines whether or not the current time is within a second block period. The second block period is a period of time from the time Ta₂ at which the first return-path predetermined time T_{SM1} elapses from a reception time at which the delay req signal is received to the time τ_{b2} at which the second return-path predetermined time T_{SM2} elapses from the reception time. The second return-path predetermined time T_{SM2} is longer than the return-path retention setting time τ_{SM}.

When determining that the current time is not within the second block period, the second transmission signal control unit 442 controls the second transmission unit 22t to transmit a normal signal. Meanwhile, when determining that the current time is within the second block period, the second transmission signal control unit 442 controls the first transmission unit 21t to stop transmitting the normal signal. Note that the normal signal received by the second reception unit 22r may be stored in the memory included in the relay device 1 until the normal signal is transmitted by the second transmission unit 22t.

The storage unit 5 includes one or more memories and may include, for example, a semiconductor memory, magnetic memory, and optical memory. Each memory included in the storage unit 5 may function as, for example, a primary storage, auxiliary storage, or cache memory. The storage unit 5 stores information. Specifically, the storage unit 5 stores arbitrary information used for operation of the relay device 1. The storage unit 5 is not necessarily provided inside the relay device 1 and may be provided outside the relay device 1. The storage unit 5 stores arbitrary information used for the operation of the relay device 1. For example, the storage unit 5 may store a system program, application program, and various types of information received by the communication unit 2.

The storage unit 5 stores the synchronization signal information indicating the synchronization signal determined by the signal determination unit 42 under the control of the retention time processing unit 43.

The storage unit 5 includes the first storage unit 51 and the second storage unit 52. The first storage unit 51 stores the synchronization signal received by the first reception unit 21r and determined by the first signal determination unit 421 under the control of the first retention time processing unit 431. The second storage unit 52 stores the synchronization signal received by the second reception unit 22r and determined by the second signal determination unit 232 under the control of the second retention time processing unit 432.

### <Configuration of Master>

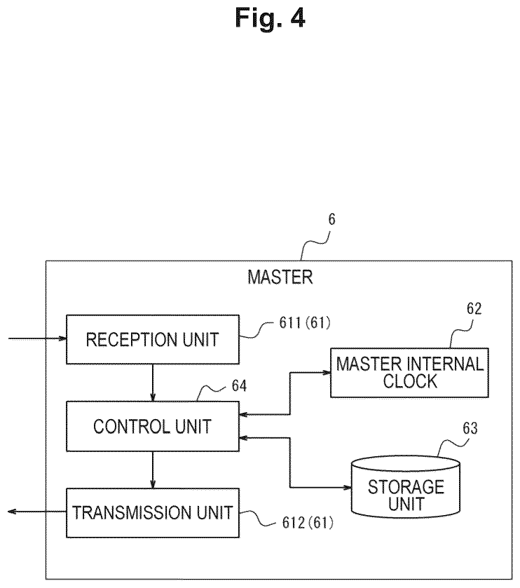

As illustrated in FIG. 4, the master 6 includes a communication unit 61, the master internal clock 62, a storage unit 63, and a control unit 64.

The communication unit 61 includes a communication interface including a reception interface and a transmission interface. The communication unit 61 includes a reception unit 611 and a transmission unit 612.

The reception unit 611 includes the reception interface. The reception unit 611 is connected to the receiver and receives a delay req signal and a normal signal transmitted from the relay device 1 via the receiver.

The transmission unit 612 includes the transmission interface. The transmission unit 612 is connected to the transmitter and transmits a signal to the relay device 1 via the transmitter. Specifically, the transmission unit 612 transmits a sync signal and a normal signal to the relay device 1. The transmission unit 612 further transmits a master time signal generated by the control unit 64 to the relay device 1.

The master internal clock 62 indicates time. Each functional unit included in the master 6 can perform various types of processing on the basis of the time indicated by the master internal clock 62. In this embodiment, the time indicated by the master internal clock 62 is used by the control unit 64 as described later.

The storage unit 63 includes one or more memories and may include, for example, a semiconductor memory, magnetic memory, and optical memory. Each memory included in the storage unit 63 may function as, for example, a primary storage, auxiliary storage, or cache memory. The storage unit 63 stores information under the control of the control unit 64. Specifically, the storage unit 63 stores arbitrary information used for operation of the master 6. The storage unit 63 is not necessarily provided inside the master 6 and may be provided outside the master 6. The storage unit 63 stores arbitrary information used for the operation of the master 6. For example, the storage unit 63 may store a system program, application program, and various types of information received by the reception unit 611.

The control unit 64 may be configured by dedicated hardware or may be configured by one or more processors. The control unit 64 can perform control by an arbitrary method by using a signal received by the reception unit 611.

The control unit 64 generates a master time signal. Specifically, when the transmission unit 612 transmits a sync signal, the control unit 64 generates a master transmission time signal. Further, when the reception unit 611 receives a delay req signal, the control unit 64 generates a master reception time signal.

### <Configuration of Slave>

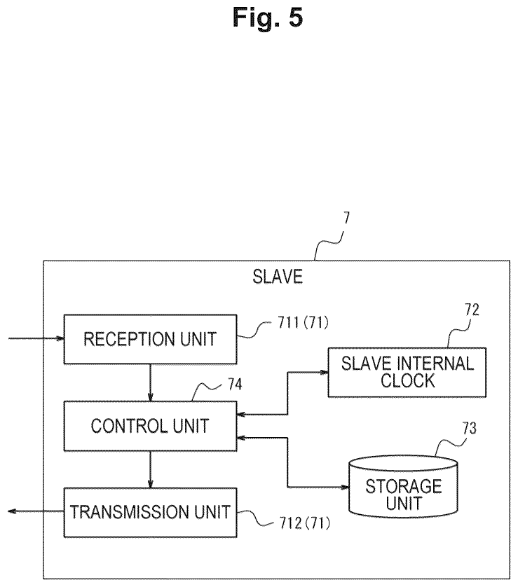

As illustrated in FIG. 5, the slave 7 includes a communication unit 71, a slave internal clock 72, a storage unit 73, and a control unit 74.

The communication unit 71 includes a communication interface including a reception interface and a transmission interface. The communication unit 71 includes a reception unit 711 and a transmission unit 712.

The reception unit 711 includes the reception interface. The reception unit 711 is connected to the receiver and receives a sync signal and a normal signal transmitted from the relay device 1 via the receiver. The reception unit 711 receives a master time signal transmitted from the relay device 1.

The transmission unit 712 includes the transmission interface. The transmission unit 712 is connected to the transmitter and transmits a signal to the relay device 1 via the transmitter. Specifically, the transmission unit 712 transmits a delay req signal and a normal signal to the relay device 1.

The slave internal clock 72 indicates time. Each functional unit included in the slave 7 can perform various types of processing on the basis of the time indicated by the slave internal clock 72. In this embodiment, the time indicated by the slave internal clock 72 is used by the control unit 74 as described later.

The storage unit 73 includes one or more memories and may include, for example, a semiconductor memory, magnetic memory, and optical memory. Each memory included in the storage unit 73 may function as, for example, a primary storage, auxiliary storage, or cache memory. The storage unit 73 stores arbitrary information used for operation of the slave 7. The storage unit 73 is not necessarily provided inside the slave 7 and may be provided outside the slave 7. The storage unit 73 stores arbitrary information used for the operation of the slave 7. For example, the storage unit 73 may store a system program, application program, and various types of information input to the reception unit 711.

The storage unit 73 stores information under the control of the control unit 74. Further, the storage unit 73 stores, in advance, information indicating the first predetermined time T₁, the second predetermined time T₂, and the retention setting time τ.

The control unit 74 may be configured by dedicated hardware or may be configured by one or more processors. The control unit 74 can perform control by an arbitrary method by using a signal received by the reception unit 711.

The control unit 74 stores, in the storage unit 73, slave time information indicating a slave time at which the communication unit 71 transmits or receives a synchronization signal. The slave time information includes slave reception time information indicating a slave reception time t₂ and slave transmission time information indicating a slave transmission time t₃. The slave reception time t₂ is a time at which the slave 7 receives a sync signal, the time being clocked by using the slave internal clock 72. The slave transmission time t₃ is a time at which the slave 7 transmits a delay req signal, the time being clocked by using the slave internal clock 72.

For example, when the reception unit 711 receives a sync signal, the control unit 74 generates the slave reception time information indicating the slave reception time t₂ and stores the slave reception time information in the storage unit 73. Further, when the transmission unit 712 transmits a delay req signal, the control unit 74 generates the slave transmission time information indicating the slave transmission time t₃ and stores the slave transmission time information in the storage unit 73. Furthermore, when the reception unit 711 receives a master time signal from the relay device 1, the control unit 74 may store information indicated by the master time signal in the storage unit 73.

The control unit 74 calculates a time difference Δt between a forward-path communication time until the slave 7 receives a signal transmitted from the master 6 and a return-path communication time until the master 6 receives a signal transmitted from the slave 7. Specifically, the control unit 74 calculates the time difference Δt as shown in Expression (2) on the basis of the master transmission time t₁, the slave reception time t₂, the slave transmission time t₃, the master reception time t₄, the forward-path retention setting time T_{M}s, and the return-path retention setting time τ_{SM}. Then, the control unit 74 corrects the slave internal clock 72 such that Δt=0 is established.

Δt=((t₂−t₁−τ_{MS})−(t₄−t₃−τ_{SM}))/2 (2)

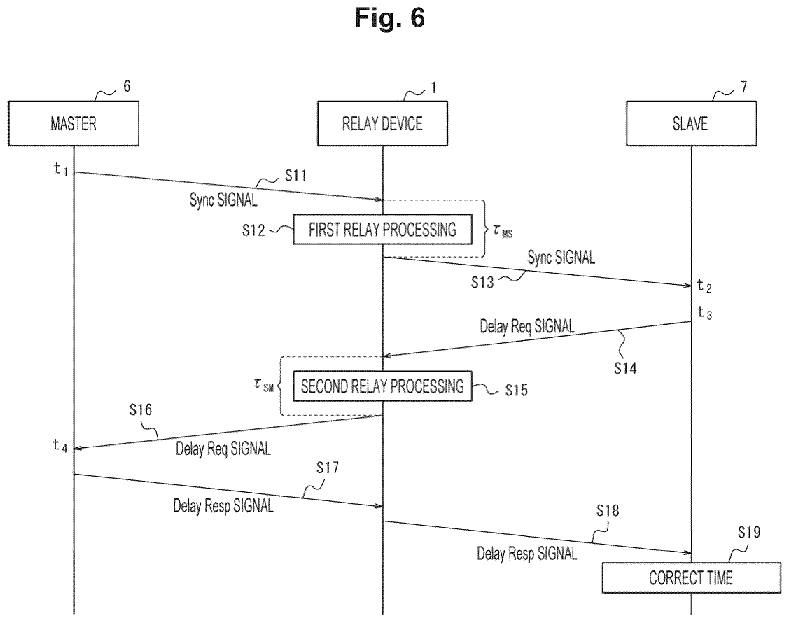

Here, an operation in time synchronization processing of the time synchronization system 100 according to the first embodiment will be described with reference to FIG. 6. FIG. 6 is a sequence diagram showing an example of the operation in the time synchronization processing of the time synchronization system 100 according to the first embodiment. The operation in the time synchronization processing of the time synchronization system 100, which will be described with reference to FIG. 6, corresponds to a time synchronization method according to the first embodiment.

In step S11, the master 6 transmits a sync signal to the relay device 1. The master 6 further transmits, to the relay device 1, a master transmission time signal indicating the master transmission time t₁ at which the sync signal has been transmitted. Note that the master 6 may transmit a normal signal to the relay device 1 before and after step S11.

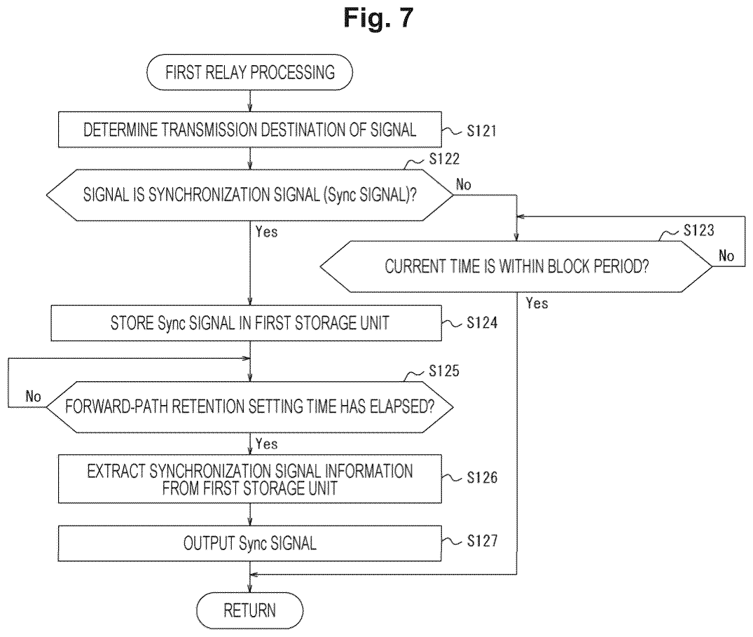

In step S12, the relay device 1 performs relay processing for transmitting the sync signal and the normal signal received from the master 6 to the slave 7. Here, the relay processing in step S12 will be described in detail with reference to FIG. 7. FIG. 7 is a flowchart showing an example of an operation in the relay processing of the relay device 1 according to the first embodiment. An operation including first relay processing described with reference to FIG. 7 corresponds to a relay method according to the first embodiment. In the first embodiment, the relay device 1 starts the relay processing when the first reception unit 21r receives the sync signal or the normal signal.

In step S121, the first path control unit 411 determines a transmission destination of the signal received by the first reception unit 21r.

In step S122, the first signal determination unit 421 determines whether the signal received by the first reception unit 21r is a synchronization signal or a normal signal, i.e., whether or not the signal is a synchronization signal.

When it is determined in step S122 that the signal is not a synchronization signal, i.e., the signal is a normal signal, the first transmission signal control unit 441 determines whether or not the current time is within the first block period in step S123.

When determining that the current time is within the first block period, the first transmission signal control unit 441 repeats the processing in step S123.

When determining that the current time is not within the first block period, the first transmission signal control unit 441 terminates the processing in step S12 and performs processing in step S13.

When it is determined in step S122 that the signal is the synchronization signal, the first retention time processing unit 431 stores synchronization signal information indicating the synchronization signal in the first storage unit 51 in step S123.

In step S124, the first retention time processing unit 431 determines whether or not the forward-path retention setting time Is has elapsed from the reception of the signal.

When determining that the forward-path retention setting time τ_{MS} has not elapsed from the reception of the signal in step S125, the first retention time processing unit 431 repeats step S125.

When determining that the forward-path retention setting time IMS has elapsed from the reception of the signal in step S125, the first retention time processing unit 431 extracts the synchronization signal information stored in the first storage unit 51 in step S126.

In step S127, the first retention time processing unit 431 outputs, to the first transmission signal control unit 441, the sync signal serving as the synchronization signal indicated by the synchronization signal information extracted in step S127.

Returning to FIG. 6, in step S13, the first transmission signal control unit 441 controls the first transmission unit 21t to transmit the signal.

Specifically, the first transmission signal control unit 441 controls the first transmission unit 21t to transmit the sync signal output from the first retention time processing unit 431 to the slave 7. The first transmission signal control unit 441 controls the first transmission unit 21t to transmit the master transmission time signal to the slave 7 following the transmission of the sync signal. The first transmission signal control unit 441 further controls the first transmission unit 21t to transmit the normal signal output from the first signal determination unit 421. Then, the slave 7 receives the sync signal and the master transmission time signal transmitted from the relay device 1. The slave 7 stores slave reception time information indicating the slave reception time t₂ at which the sync signal has been received.

In step S14, the slave 7 transmits a delay req signal to the relay device 1. The slave 7 also generates and stores slave transmission time information. Note that the slave 7 may transmit a normal signal to the relay device 1 before and after step S14.

In step S15, the relay device 1 performs second relay processing for transmitting the delay req signal and the normal signal received from the slave 7 to the master 6. The return-path retention setting time ism used in the second relay processing may be different from the forward-path retention setting time τ_{MS}. The second relay processing is the same as the first relay processing, except for the return-path retention setting time ism.

In step S16, the second transmission signal control unit 442 controls the second transmission unit 22t to transmit the delay req signal output from the second retention time processing unit 432 to the master 6. The second transmission signal control unit 442 further controls the second transmission unit 22t to transmit the normal signal output from the second signal determination unit 422. The master 6 receives the delay req signal transmitted from the relay device 1. The master 6 generates a master reception time signal.

In step S17, the master 6 transmits a delay resp signal to the relay device 1. The master 6 further transmits the master reception time signal to the relay device 1.

In step S18, the relay device 1 transmits the delay resp signal received from the master 6 to the slave 7. The relay device 1 further transmits the master reception time signal received from the master 6 to the slave 7. The slave 7 receives the delay resp signal and the master reception time signal transmitted from the relay device 1.

In step S19, the slave 7 corrects the time indicated by the slave internal clock 72 on the basis of the master transmission time t₁, the slave reception time t₂, the slave transmission time t₃, the master reception time t₄, the forward-path retention setting time T_{M}s, and the return-path retention setting time τ_{SM}.

As described above, according to the first embodiment, the relay device 1 stops transmitting a normal signal when the first predetermined time T₁ elapses from the reception of the synchronization signal and extracts the synchronization signal information from the storage unit 5 when the retention setting time τ longer than the first predetermined time T₁ elapses. Therefore, at least one of normal signals whose transmission processing is started after the reception of the synchronization signal is transmitted within the retention setting time τ. Thus, the relay device 1 can reduce a delay caused by the transmission processing of the normal signals and can transmit the normal signals when the known retention setting time τ elapses. Therefore, the slave 7 can accurately calculate the forward-path communication time and the return-path communication time by using an accurate period of time required for the relay device 1 to transmit the synchronization signal after the reception of the synchronization signal. The slave 7 can accurately calculate the time difference Δt and can therefore accurately correct the time of the slave internal clock 72. Accordingly, the time synchronization system 100 accurately performs time synchronization between the master 6 and the slave 7 that transmit and receive a signal via the relay device 1.

According to the first embodiment, the relay device 1 does not need to include a master function unit or a slave function unit and can therefore be simply configured. Further, according to the first embodiment, the slave 7 can calculate the time difference Δt without using a transmission/reception time of the synchronization signal in the relay device 1. Therefore, even in a case where the master 6 and the slave 7 communicate with each other via a large number of relay devices 1, the slave 7 does not need to receive signals indicating the transmission/reception times of the large number of relay devices 1 and can therefore be simply configured.

In the first embodiment, the first predetermined time T₁ and the retention setting time τ may be set such that the period of time between the time τₐ at which the first predetermined time T₁ elapses from the reception of the synchronization signal and the time τ_{c} at which the retention setting time τ elapses from the reception of the synchronization signal is equal to or longer than the period of time from the start to the end of transmission of a normal signal. Therefore, a waiting time for transmission processing of the synchronization signal, which is caused by the transmission processing of the normal signal, can be reliably reduced. Thus, the slave 7 can calculate the time difference Δt more accurately.

In the first embodiment, the first path control unit 411 determines a transmission destination of a signal in step S121, and then the first signal determination unit 421 determines whether or not the signal is a synchronization signal in step S122. However, the present disclosure is not limited thereto, and the first path control unit 411 may determine the transmission destination of the signal at any timing after step S122 and before step S13.

### Second Embodiment

Hereinafter, a second embodiment of the present disclosure will be described. A time synchronization system 100 according to the second embodiment includes a relay device 1, a master 6, and a slave 7.

In the second embodiment, the relay device 1 is configured as a computer. The relay device 1 includes a communication unit 2, a device internal clock 3, a control unit 4, and a storage unit 5. The communication unit 2, the device internal clock 3, and the storage unit 5 in the second embodiment are the same as the communication unit 2, the device internal clock 3, and the storage unit 5 in the first embodiment, respectively.

The control unit 4 includes a processor. The control unit 4 includes a path control unit 41, a signal determination unit 42, a retention time processing unit 43, and a transmission signal control unit 44. The path control unit 41, the signal determination unit 42, and the transmission signal control unit 44 in the second embodiment are the same as the path control unit 41, the signal determination unit 42, and the transmission signal control unit 44 in the first embodiment, respectively. The retention time processing unit 43 includes a first retention time processing unit 431 and a second retention time processing unit 432. The first retention time processing unit 431 is the same as the first retention time processing unit 431 in the first embodiment.

In the second embodiment, processing of the second retention time processing unit 432 is different from that in the first embodiment. Specifically, in the second embodiment, the return-path retention setting time τ_{SM} is the same as the forward-path retention setting time τ_{MS}. That is, the second retention time processing unit 432 in the second embodiment determines whether or not the return-path retention setting time τ_{SM} that is the same as the forward-path retention setting time τ_{MS} has elapsed from reception of a delay req signal by using the time indicated by the device internal clock 3. Then, when determining that the return-path retention setting time τ_{SM} has not elapsed from the reception of the delay req signal, the second retention time processing unit 432 continuously stores the synchronization signal in the second storage unit 52, as in the first embodiment. When determining that the return-path retention setting time τ_{SM} has elapsed from the reception of the delay req signal, the second retention time processing unit 432 extracts, from the second storage unit 52, synchronization signal information indicating the delay req signal stored in the second storage unit 52. Then, the second retention time processing unit 432 outputs the delay req signal indicating the synchronization signal information to the first transmission signal control unit 441.

The master 6 in the second embodiment is the same as the master 6 in the first embodiment. The slave 7 in the second embodiment is configured as a computer. The slave 7 in the second embodiment includes a communication unit 71, a slave internal clock 72, a storage unit 73, and a control unit 74. The communication unit 71, the slave internal clock 72, and the storage unit 73 in the second embodiment are the same as the communication unit 71, the slave internal clock 72, and the storage unit 73 in the first embodiment, respectively.

The control unit 74 of the slave 7 in the second embodiment includes a processor. Unlike the first embodiment, the control unit 74 of the slave 7 in the second embodiment calculates a time difference Δt on the basis of Expression (3) obtained by transforming Expression (2) by using τ_{MS}=τ_{SM}. Then, the control unit 74 in the second embodiment corrects the time indicated by the slave internal clock 72 such that Δt=0 is established.

Δt=((t₂−t₁)−(t₄−t₃))/2 (3)

As described above, according to the second embodiment, the return-path retention setting time τ_{SM} is the same as the forward-path retention setting time τ_{MS}. Thus, the slave 7 that communicates with the master 6 via the relay device 1 can easily calculate the time difference Δt, as compared with the first embodiment. Therefore, the processing load of the slave 7 is reduced. In particular, in a configuration in which the master 6 and the slave 7 transmit and receive a signal to and from each other via a large number of relay devices 1 and the return-path retention setting time τ_{SM} is different from the forward-path retention setting time τ_{MS}, the slave 7 needs to calculate the time difference at on the basis of the forward-path retention setting time TIs and the return-path retention setting time τ_{SM} of each of the large number of relay devices 1. Meanwhile, in a case where the relay device 1 is configured as in the second embodiment described above, the processing load of the slave 7 is greatly reduced. Therefore, the relay device 1 in the second embodiment can easily implement highly accurate time synchronization between the master 6 and the slave 7.

### Third Embodiment

Next, a third embodiment of the present disclosure will be described with reference to the drawings.

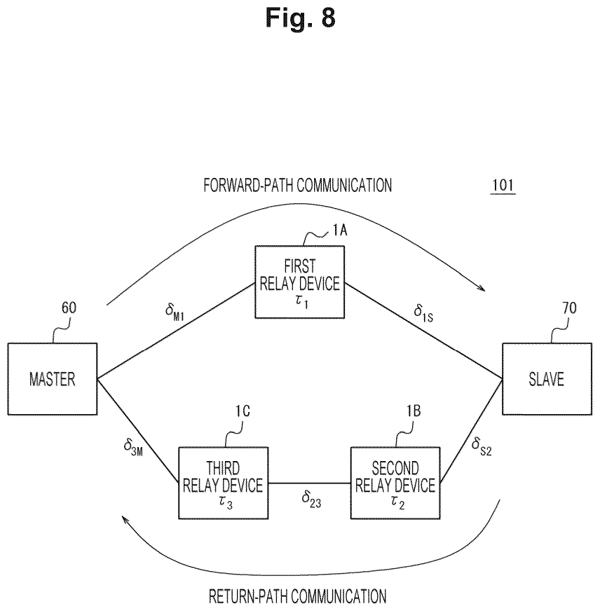

First, an entire configuration of the third embodiment will be described with reference to FIG. 8. FIG. 8 is a schematic diagram of a time synchronization system 101 according to the third embodiment of the present invention.

As illustrated in FIG. 8, the time synchronization system 101 according to the third embodiment includes a first relay device 1A, a second relay device 1B, a third relay device 1C, a master 60, and a slave 70.

The first relay device 1A, the second relay device 1B, the third relay device 1C, the master 60, and the slave 70 are each configured as a computer. The first relay device 1A, the second relay device 1B, and the third relay device 1C are the same as the relay device 1 in the first embodiment. The master 60 in the third embodiment is the same as the master 6 in the first embodiment. In the third embodiment, unlike the first embodiment, a communication path in the forward-path communication in which a signal is transmitted from the master 60 to the slave 70 is different from a communication path in the return-path communication in which a signal is transmitted from the slave 70 to the master 60. In the example of FIG. 8, the master 6 transmits a signal to the slave 70 via the first relay device 1A. The slave 70 transmits a signal to the master 60 via the second relay device 1B and the third relay device 1C.

The slave 70 includes a communication unit 701, a clock 702, a storage unit 703, and a control unit 704. The communication unit 701, the clock 702, and the storage unit 703 in the third embodiment are the same as the communication unit 71, the slave internal clock 72, and the storage unit 73 in the first embodiment, respectively.

The control unit 704 in the third embodiment is different from the control unit 74 in the first embodiment. Hereinafter, the control unit 704 will be described in detail.

The control unit 704 calculates a time difference Δt on the basis of the master transmission time t₁, the slave reception time t₂, the slave transmission time t₃, the master reception time t₄, the retention setting time τ, and a communication time δ. The retention setting time τ includes a retention setting time τ₁, a retention setting time 12, and a retention setting time τ₃ required until the first relay device 1A, the second relay device 1B, and the third relay device 1C, respectively, transmit a synchronization signal after receiving the synchronization signal. The communication time δ is a period of time during which a signal is propagated through a communication network from one of devices including the master 60, the slave 70, the first relay device 1A, the second relay device 1B, and the third relay device 1C included in the time synchronization system 101 to another device. In this example, the communication time δ includes a communication time δ_{M1} from when a signal is transmitted from the master 60 to when the signal is received by the first relay device 1A and a communication time δ_{1S} from when the signal is transmitted from the first relay device 1A to when the signal is received by the slave 70. The communication time δ further includes a communication time δ_{S2} from when a signal is transmitted from the slave 70 to when the signal is received by the second relay device 1B and a communication time δ₂₃ from when the signal is transmitted from the second relay device 1B to when the signal is received by the third relay device 1C. The communication time δ further includes a communication time δ_{3M} from when the signal is transmitted from the third relay device 1C to when the signal is received by the master 60.

Specifically, the control unit 704 calculates a forward-path communication time by subtracting all the retention setting times τ in the relay device that relays a signal in the forward-path communication and all the communication times δ in the forward-path communication from a period of time from the slave reception time t₂ to the master transmission time t₁. Further, the control unit 704 calculates a return-path communication time by subtracting all the retention setting times τ in the relay devices that relay a signal in the return-path communication and all the communication times δ in the return-path communication from a period of time from the master reception time t₄ to the slave transmission time t₃. The control unit 704 calculates ½ of a difference between the forward-path communication time and the return-path communication time as the time difference Δt.

In the example of FIG. 8, the control unit 704 calculates the time difference Δt as shown in Expression (4). The control unit 704 corrects time indicated by the clock 702 such that Δt=0 is established.

Δt=((t₂−t₁−τ₁−δ_{M1}−δ1S)−(t₄−t₃−τ₂−τ₃−δ_{S3}−δ₃₂−δ_{2M}))/2 (4)

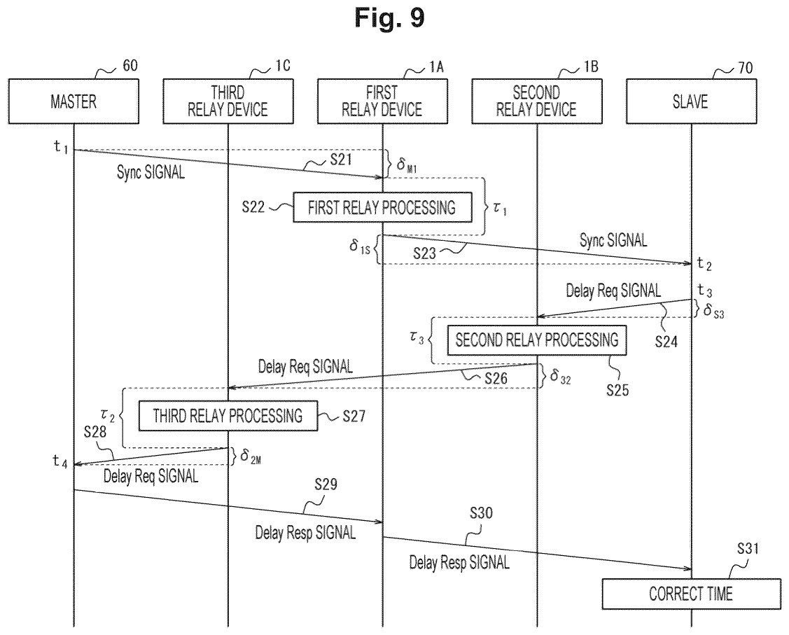

Here, an operation in time synchronization processing of the time synchronization system 101 according to the third embodiment will be described with reference to FIG. 9. FIG. 9 is a sequence diagram showing an example of the operation in the time synchronization processing of the time synchronization system 101 according to the third embodiment. The operation in the time synchronization processing of the time synchronization system 101, which will be described with reference to FIG. 9, corresponds to a time synchronization method according to the third embodiment.

In step S21, the master 60 transmits a signal. In step S22, the first relay device 1A performs first relay processing on the signal transmitted from the master 60. In step S23, the first relay device 1A transmits the signal to the slave 70, and the slave 70 receives the signal transmitted from the first relay device 1A. The processing in steps S21 to S23 is the same as the processing in steps S11 to S13 in the first embodiment.

Then, in step 24, the slave 70 transmits a signal. In step S25, the second relay device 1B performs second relay processing on the signal transmitted from the slave 70. The processing in steps S24 and S25 is the same as the processing in steps S14 and S15 in the first embodiment.

In step S26, the second relay device 1B transmits the signal transmitted from the slave 70 to the third relay device 1C. In step S27, the third relay device 1C performs third relay processing on the signal transmitted from the second relay device 1B. The processing in steps S26 and S27 is the same as the processing in steps S14 and S15 in the first embodiment.

In step S28, the third relay device 1C transmits the signal to the master 60. The processing in step S28 is the same as the processing in step S16 in the first embodiment.

In step S29, the master 60 transmits a signal to the first relay device 1A. In step S30, the first relay device 1A transmits the signal transmitted from the master 60 to the slave 70. The processing in steps S29 and S30 is the same as the processing in steps S17 and S18 in the first embodiment.

In step S31, the slave 7 calculates the time indicated by the slave internal clock 72 on the basis of the master transmission time t₁, the slave reception time t₂, the slave transmission time t₃, the master reception time ta, the forward-path retention setting time τ_{MS}, the return-path retention setting time τ_{SM}, and the retention setting times τ₁ to τ₃.

As described above, according to the third embodiment, the slave 70 calculates the time indicated by the slave internal clock 72 on the basis of not only the master transmission time t₁, the slave reception time t₂, the slave transmission time t₃, the master reception time t₄, and the retention setting time τ, but also the communication time δ. Therefore, the slave 70 can accurately calculate the time difference Δt even in a configuration in which the communication path in the forward-path communication is different from the communication path in the return-path communication. Thus, the slave 70 can accurately correct the time indicated by the slave internal clock 72. Accordingly, the time synchronization system 101 accurately performs time synchronization between the master 6 and the slave 7.

In the third embodiment, one relay device relays a signal in the forward-path communication, but the present disclosure is not limited thereto, and two or more relay devices may relay a signal. Further, two relay devices relay a signal in the return-path communication, but the present disclosure is not limited thereto, and one or three or more relay devices may relay a signal.

The communication paths in both the forward-path communication and the return-path communication may be determined in advance. The communication paths in both the forward-path communication and the return-path communication may be determined by the relay device at an arbitrary timing by an arbitrary method. In this case, the relay device may cause a synchronization signal to include a signal indicating a communication path and transmit the synchronization signal to the slave 7.

The communication time δ may be determined on the basis of a length of an optical fiber included in the communication network for connecting the relay devices. One relay device may transmit a signal to another relay device serving as a transmission destination that transmits the signal next, and the another relay device may transmit the signal to the one relay device by loopback or the like. In such a configuration, the communication time δ is determined on the basis of a period of time from when the one relay device transmits a signal to when the one relay device receives the signal.

In the third embodiment, the retention setting time τ of each of the relay devices 1A to 1C may be set such that the sum of the retention setting time τ and the communication time δ in the forward-path communication is equal to the sum of the retention setting time τ and the communication time δ in the return-path communication. In the examples of FIGS. 8 and 9, the retention setting times τ₁, τ₂, and τ₃ may be set to satisfy Expression (5).

τ₁+τ_{M1}+δ_{1S}=τ₂+τ₃+δ_{S3}+δ₃₂+δ_{2M} (5)

Therefore, Expression (4) used when the slave 70 calculates the time difference Δt is transformed as shown in Expression (3) by using Expression (5). Thus, the slave 70 can easily calculate the time difference Δt for the same reason as that in the second embodiment. Accordingly, the processing load of the slave 70 is reduced.

In order to function as the above embodiments, a computer capable of executing a program instruction can also be used. The computer can be implemented by storing a program in which processing content for implementing the function of each device is written in a storage unit of the computer and reading and executing the program by using a processor of the computer. At least part of the processing content may be implemented by hardware. The program instruction may be a program code, code segment, or the like for executing required tasks.

The program may be recorded in a computer-readable recording medium. Using such a recording medium makes it possible to install the program in the computer. Here, the recording medium in which the program is recorded may be a non-transitory recording medium. The non-transitory recording medium may be a compact disk (CD)-read-only memory (ROM), a digital versatile disc (DVD)-ROM, a Blu-ray Disc (registered trademark) (BD)-ROM, or the like. Further, the program can also be provided by being downloaded via a network.

Although the above-described embodiments have been described as representative examples, it is apparent to those skilled in the art that many modifications and substitutions can be made within the spirit and scope of the present disclosure. Therefore, it should not be understood that the present invention is limited by the above-described embodiments, and various modifications or changes can be made within the scope of the claims. For example, a plurality of configuration blocks illustrated in the configuration diagrams of the embodiments can be combined into one, or one configuration block can be divided.

### REFERENCE SIGNS LIST

1 Relay device
1A First relay device
1B Second relay device
1C Third relay device
2, 61, 71 Communication unit
3 Device internal clock
4, 63, 74 Control unit
5, 73 Storage unit
6, 60 Master
7, 70 Slave
21r First reception unit
21t First transmission unit
22r Second reception unit
22t Second transmission unit
41 Path control unit
42 Signal determination unit
43 Retention time processing unit
44 Transmission signal control unit
51 First storage unit
52 Second storage unit
62 Master internal clock
72 Slave internal clock
100, 101 Time synchronization system
411 First path control unit
412 Second path control unit
421 First signal determination unit
422 Second signal determination unit
431 First retention time processing unit
432 Second retention time processing unit
441 First transmission signal control unit
442 Second transmission signal control unit

1. A relay device comprising:
a device internal clock to indicate time;
a memory to store information;
communication circuitry configured to transmit and receive a signal including a synchronization signal and a normal signal to and from a master and a slave;
retention time processing circuitry configured to store synchronization signal information indicating the synchronization signal received by the communication circuitry in the memory and extract the synchronization signal information from the memory when a retention setting time longer than a first predetermined time elapses from the reception of the synchronization signal by using the time indicated by the device internal clock; and
transmission signal control circuitry configured to control the communication circuitry to stop transmitting the normal signal when the first predetermined time elapses from the reception of the synchronization signal and transmit the synchronization signal indicating the synchronization signal information when the synchronization signal information is extracted from the memory.

2. The relay device according to claim 1, wherein
the first predetermined time includes a first forward-path predetermined time and a first return-path predetermined time,
the retention setting time includes a forward-path retention setting time and a return-path retention setting time,
the communication circuitry includes a first reception circuitry configured to receive the signal from the master and a second reception circuitry configured to receive the signal from the slave,
the memory includes a first memory and a second memory,
the retention time processing circuity includes first retention time processing circuitry and second retention time processing circuitry,
the first retention time processing circuitry stores the synchronization signal information indicating the synchronization signal received by the first reception circuitry in the first memory and extracts the synchronization signal information stored in the first memory when the forward-path retention setting time longer than the first forward-path predetermined time elapses from the reception of the synchronization signal, and
the second retention time processing circuitry stores the synchronization signal information indicating the synchronization signal received by the second reception circuitry in the second memory and extracts the synchronization signal information stored in the second memory when the return-path retention setting time longer than the first return-path predetermined time elapses from the reception of the synchronization signal.

3. The relay device according to claim 2, wherein the return-path retention setting time is the same as the forward-path retention setting time.

4. The relay device according to claim 1, wherein when a second predetermined time longer than the retention setting time elapses from the reception of the synchronization signal, the transmission signal control circuitry controls the communication circuitry to start transmitting the normal signal received by the communication circuitry.

5. A time synchronization system comprising:
the relay device according to claim 1; and
a master and slave configured to communicate with the relay device, wherein
the communication circuitry transmits, from the master to the slave, a master time signal indicating a master time at which the master transmits and receives the synchronization signal, and
the slave includes a slave internal clock and corrects the slave internal clock on the basis of a slave time indicating a time at which the slave transmits and receives the synchronization signal, the master time, and the retention setting time.

6. The time synchronization system according to claim 5, wherein the slave corrects the slave internal clock further on the basis of a communication time that is a period of time during which the synchronization signal is propagated through a communication network.

7. A program for causing a computer to function as the relay device according to claim 1.
